(19) United States
(12) Patent Application Publication
(10) Pub. No.: US 2008/0063812 A1
(43) Pub. Date: Mar. 13, 2008

(54) Method for Manufacturing an Optical Preform

(75) Inventors: Rob Hubertus Matheus Deckers, Eindhoven (NL); Mattheus Jacobus Nicolaas Van Stralen, Tilburg (NL); Johannes Antoon Hartsuiker, Eindhoven (NL)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: DRAKA COMTEQ B.V., Amsterdam (NL)

(21) Appl. No.: 11/851,595

(22) Filed: Sep. 7, 2007

(30) Foreign Application Priority Data
Sep. 8, 2006 (NL) 1032463

(51) Int. Cl. H05H 1/24

(52) U.S. Cl. 427/575; 427/578

(57) ABSTRACT

The present invention relates to a method for manufacturing an optical preform by carrying out one or more chemical vapor deposition reactions in a substrate tube. The method includes the steps of (i) supplying one or more doped or undoped glass-forming precursors to a substrate tube and (ii) effecting a reaction between these glass-forming precursors to form one or more glass layers on the interior of the substrate tube via the creation of a pulsed plasma zone in the interior of the substrate tube.

### CROSS-REFERENCE TO PRIORITY APPLICATION

This application claims the benefit of pending Dutch Application No. 1,032,463 (filed Sep. 8, 2006, at the Dutch Patent Office), which is hereby incorporated by reference in its entirety.

### FIELD OF THE INVENTION

The present invention relates to an improved method for manufacturing an optical preform by carrying out one or more chemical vapor deposition reactions in a substrate tube.

### BACKGROUND OF THE INVENTION

Chemical vapor deposition (CVD) and plasma chemical vapor deposition (PCVD) are known in the art.

For example, International Publication No. WO 03/057635 mentions as a PCVD shortcoming the low glass-deposition rate, and explains that one way to increase the deposition rate is to increase the mass flow rate of the glass-forming precursors in the interior of the substrate tube. This, however, causes the pressure in the tube to increase, which may lead to the deposition of so-called soot particles instead of glass. This publication further explains that increasing the mass flow rate of the glass-forming precursors may also lead to the reactant gases passing through the plasma zone before the glass-forming precursors are actually converted into a glass layer, resulting in a considerable loss of material and possibly in a non-uniform radial profile along the axial axis of the substrate tube.

International Publication No. WO 03/057635 proposes to create so-called eddy diffusion by pulsing an energy source to form the plasma, and explains that this may include charging microwaves to an activator chamber on a periodic or non-periodic basis. International Publication No. WO 03/057635, however, provides no additional data in this regard.

German Patent No. 3,830,622 discloses a method for manufacturing an optical preform by using a pulsed plasma zone to deposit glass layers on the interior of the substrate tube. The disclosed apparatus consists of a plasma-electrode that extends over the entire length of the substrate tube. Both the plasma-electrode and the substrate tube are surrounded by a furnace for obtaining high temperatures. According to this patent publication, the deposition length on the interior of the substrate tube is its entire length (i.e., about 80 centimeters, at a plasma power of 5-10 kW, a pulse pause of 10 milliseconds, and a pulse time of 1.5 milliseconds).

### SUMMARY OF THE INVENTION

It is an object of the present invention to provide a method for improving the efficiency of glass deposition.

It is another object of the present invention to provide a PCVD method for manufacturing an optical preform in a way that achieves high deposition rates.

It is yet another object of the present invention to provide a PCVD method for manufacturing an optical preform in a way that achieves high deposition rates in combination with a decrease in average microwave power.

In accordance with the present invention, optical fiber preforms are produced via an internal chemical vapor deposition technique (CVD). The CVD process involves the deposition of doped or undoped, reactive, glass-forming gases on the inside of a hollow substrate tube. Such reactive gases, which are supplied on one side of the substrate tube (i.e., the entrance side), form a glass layer on the interior of the substrate tube under certain process conditions. An energy source is reciprocated between two reversal points along the substrate tube to promote the formation of the glass layer. The energy source, such as a plasma generator, supplies high-frequency energy to generate a plasma in the interior of the substrate tube, under which conditions the reactive, glass-forming gases will react (i.e., a plasma CVD technique).

The foregoing, as well as other objectives and advantages of the invention, and the manner in which the same are accomplished, are further specified within the following detailed description and its accompanying drawing.

### BRIEF DESCRIPTION OF THE DRAWINGS

FIG. 1 schematically illustrates the pulsed plasma power supplied to a substrate tube as a function of time.

### DETAILED DESCRIPTION

Accordingly, the present invention provides an improved method for manufacturing an optical preform by carrying out one or more chemical vapor deposition reactions in a substrate tube by (i) supplying one or more doped or undoped glass-forming precursors (i.e., the reactants) to a substrate tube and (ii) effecting a reaction between these reactants to form one or more glass layers on the interior of the substrate tube via the creation of only a pulsed plasma zone in the interior of the substrate tube. This pulsed plasma zone is realized in pulses, typically using a frequency at least 100 Hz, with a maximum plasma power being active each pulse cycle for a period of between 0.001 and 5 milliseconds. In certain embodiments, the pulse frequency is at least 1500 Hz.

The present inventors have found that when high deposition rates are sought at increased microwave power, a considerable part of the microwave energy is eventually converted into heat. This can lead to overheating of equipment components used in the PCVD process, which in turn requires additional cooling. Another drawback of such a temperature increase is a reduced incorporation efficiency of dopants in the deposited glass layers, particularly with respect to germanium dioxide.

In comparison with a continuous PCVD process, the present invention makes it possible to achieve high deposition rates in the PCVD process while using a lower average microwave power. As a result, the temperature in the interior of the substrate tube decreases such that the incorporation efficiency of dopants in the glass layers is not adversely affected.

According to the present invention, the plasma power in the aforementioned step (ii) is set to a value between a maximum power and a value lower than this maximum power. In other words, during the deposition process the plasma power is controlled in a pulsed manner between a maximum power and a relatively lower power (i.e., less than the peak plasma power that is set for the glass deposition).

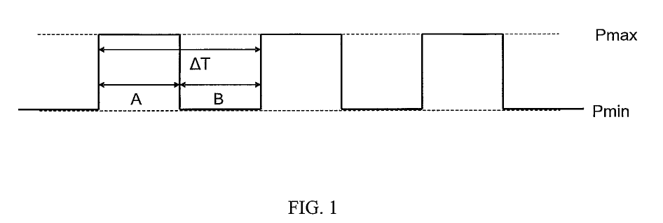

In this regard, the phrase “maximum plasma power” and the like should be understood to mean the power that would be set for a specific deposition rate if a constant-plasma PCVD process were employed (e.g., a PCVD process that maintains a substantially constant plasma intensity during the deposition of glass layers on the interior of the substrate tube). In other words, the “maximum plasma power” (or “peak plasma power”) defines plasma power Pₘₐₓ as depicted in FIG. 1. The phrase “maximum plasma power” as used herein does not refer to the power that could be maximally generated by the PCVD equipment.

By way of example, the peak power used in the pulsed plasma zone is set so that the deposition rate of the glass layers is at least 2.0 g/min (e.g., about 3.2 g/min or more).

FIG. 1 schematically represents the plasma power supplied to the substrate tube as a function of time. In this regard, period A (i.e., an elevated-plasma-power period) indicates the time (seconds) during which the plasma is set to the plasma power Pₘₐₓ (i.e., the maximum plasma power). Then, the plasma power is reduced for a specific period, indicated by period B (i.e., a reduced-plasma-power period). The plasma power is thus alternated between values Pₘₐₓ and Pₘᵢₙ. The corresponding frequency can be understood to be the number of pulses per second, namely 1/(A+B), wherein (A+B) defines ΔT, the period for a complete pulse cycle. In practice, the phrase “duty cycle” is also used, which may be interpreted as A/ΔT (or A·f, where f is the pulse frequency).

According to the present invention, the period during which the plasma power is set to a maximum power (i.e., period A in FIG. 1) typically ranges between 0.001 and 5 milliseconds. It has been found that if period A is much less than 0.001 milliseconds, the plasma in the substrate tube will be unstable and ineffective, making the deposition of glass layers impractical if not impossible. On the other hand, if period A is much more than 5 milliseconds, too much heat tends to be produced in the substrate tube. As noted, this excessive heat has a negative effect on the incorporation efficiency of dopants and leads to a considerably increased temperature load on equipment components.

According to the present invention, the length of the plasma in the interior of the substrate tube is about 15 to 30 centimeters, whereas the substrate tube itself has a length of about 100 to 120 centimeters.

During the aforementioned deposition step (ii), the resonator, in which the plasma is generated, travels back and forth along the length of the substrate tube between two points, namely a first reversal point located at the supply side of the substrate tube and a second reversal point located at the discharge side of the substrate tube.

To obtain a stable PCVD process, the plasma power is typically set to a value below the maximum power for a period of 5 milliseconds or less, more typically 1 millisecond or less. For example, as schematically depicted in FIG. 1, reduced plasma power Pₘᵢₙ is applied during period B. In certain embodiments of the present method, the duration of period B is set to 0.1 millisecond or less. This has been found to reduce the risk of soot formation.

The plasma power during period B is typically less than 50 percent of the plasma power employed during period A, more typically less than 25 percent (e.g., 10 percent or less of the plasma power used during period A). Furthermore, during period B it is possible to set the plasma power to zero (i.e., “off”).

The present inventors have found that, as compared with a constant-plasma PCVD process (i.e., employing constant, maximum plasma power), the pulsed-plasma PCVD process achieves comparable glass deposition rates but with significantly less heat generation. The reduced heat improves the incorporation efficiency of dopants (e.g., germanium dioxide). Moreover, the present method makes it possible to increase the deposition rate without overheating the equipment used therewith.

In the specification and the figures, typical embodiments of the invention have been disclosed. The present invention is not limited to such exemplary embodiments. Specific terms have been used only in a generic and descriptive sense, and not for purposes of limitation. The scope of the invention is set forth in the following claims.

1. A method for manufacturing an optical preform by carrying out one or more chemical vapor deposition reactions in a substrate tube, the method comprising the following steps:
(i) supplying one or more doped or undoped glass-forming precursors to the substrate tube; and
(ii) effecting a reaction between the glass-forming precursors in the substrate tube so as to form one or more glass layers on the interior of the substrate tube;
wherein step (ii) comprises creating in the interior of the substrate tube only a pulsed plasma zone, wherein the pulsed plasma zone is realized in pulses at a frequency of more than 100 Hz and wherein the maximum plasma power is active between 0.001 and 5 milliseconds per pulse cycle.

2. A method according to claim 1, wherein the maximum plasma power is set to a value that corresponds to a deposition rate of glass layers in the interior of the substrate tube that is obtained when the plasma power is not pulsed.

3. A method according to claim 1, wherein the pulse frequency is at least 1500 Hz.

4. A method according to claim 1, wherein the maximum plasma power in the pulsed plasma zone is set to a value such that the deposition rate of the glass layers is at least 2.0 g/min.

5. A method according to claim 1, wherein the plasma power is set to a value below the maximum plasma power for a period of less than 5 milliseconds per pulse cycle.

6. A method according to claim 1, wherein the plasma power is set to a value below the maximum plasma power for a period of less than 1 millisecond per pulse cycle.

7. A method according to claim 1, wherein, as depicted in FIG. 1, the plasma power during period B is less than 50 percent of the plasma power during period A.

8. A method according to claim 1, wherein, as depicted in FIG. 1, the plasma power during period B is less than 25 percent of the plasma power during period A.

9. A method according to claim 1, wherein, as depicted in FIG. 1, the plasma power during period B is less than 10 percent of the plasma power during period A.

10. A method of making an optical preform via pulsed-plasma chemical vapor deposition, comprising:
supplying glass-forming precursors to a substrate tube;
supplying microwave energy to the substrate tube in alternating pulses of elevated plasma power (Pₘₐₓ) for an elevated-plasma-power period A and reduced plasma power (Pₘᵢₙ) for a reduced-plasma-power period B to achieve a plasma zone in the interior of the substrate tube; and
effecting a reaction between the glass-forming precursors to form one or more glass layers on the interior of the substrate tube;
wherein elevated-plasma-power period A is between about 0.001 and 5 milliseconds;
wherein reduced-plasma-power period B is about 5 milliseconds or less; and
wherein the reduced plasma power (Pₘᵢₙ) is less than about 50 percent of the elevated plasma power (Pₘₐₓ).

11. A method according to claim 10, wherein the reduced-plasma-power period B is 1 millisecond or less.

12. A method according to claim 10, wherein the reduced-plasma-power period B is 0.1 millisecond or less.

13. A method according to claim 10, wherein the reduced plasma power (Pₘᵢₙ) is less than about 25 percent of the elevated plasma power (Pₘₐₓ).

14. A method according to claim 10, wherein the reduced plasma power (Pₘᵢₙ) is less than about 10 percent of the elevated plasma power (Pₘₐₓ).

15. A method according to claim 10, wherein the reduced plasma power (Pₘᵢₙ) is about 0 percent of the elevated plasma power (Pₘₐₓ).

16. A method according to claim 10, wherein the pulse frequency, (A+B)⁻¹, is more than about 100 Hz.

17. A method according to claim 10, wherein the pulse frequency, (A+B)⁻¹, is more than about 1500 Hz.

18. A method of making an optical preform via pulsed-plasma chemical vapor deposition, comprising:
supplying doped and/or undoped glass-forming precursors to a substrate tube; and
producing a pulsed plasma zone in the interior of the substrate tube to cause the glass-forming precursors to react and thereby form one or more glass layers on the interior of the substrate tube;
wherein the step of producing a pulsed plasma zone comprises supplying energy to the substrate tube in pulses of elevated plasma power (Pₘₐₓ) and reduced plasma power (Pₘᵢₙ), the reduced plasma power (Pₘᵢₙ) being less than about 25 percent of the elevated plasma power (Pₘₐₓ).

19. A method according to claim 18, wherein the step of supplying energy in pulses of elevated plasma power (Pₘₐₓ) and reduced plasma power (Pₘᵢₙ) comprises supplying energy in alternating pulses of elevated plasma power (Pₘₐₓ) and reduced plasma power (Pₘᵢₙ) at a frequency of at least 100 Hz.

20. A method according to claim 18, wherein the step of supplying energy in pulses of elevated plasma power (Pₘₐₓ) and reduced plasma power (Pₘᵢₙ) comprises supplying energy in alternating pulses of elevated plasma power (Pₘₐₓ) and reduced plasma power (Pₘᵢₙ) at a frequency of at least 1500 Hz.
